(19) United States
(12) Patent Application Publication
(10) Pub. No.: US 2004/0084889 A1
(43) Pub. Date: May 6, 2004

(54) Resilient supportive structure

(76) Inventor: Rudolph G. Larson, Aurora, IL (US)

Correspondence Address: RUDOLPH G. LARSON, P. O. BOX 5654, AURORA, IL, 60507, US

(21) Appl. No.: 10/289,350

(22) Filed: Nov. 6, 2002

(51) Int. Cl. B62D 21/00

(52) U.S. Cl. 280/788

(57) ABSTRACT

Two or more pre-selected rigid frames from the group (1),(5),(8), or (9), maintained in semi-rigid conformance by pre-determinably spaced cross beams (15),(16A),(16B). Each beam is elastically isolated from members (28A),(28B),(28C) of the rigid frames (1),(5),(8), or (9), by intervening resilient inserts (26A), (26B). In addition, the application of the RESILIENT SUPPORTIVE STRUCTURE to a mobile device with wheels (31) or casters (40A)(40B). In addition, a platform assembly (30), a power source [M] or [E], a rotary power transmitting device [GB], driving wheel assembly (12), steering mechanism levers (46A)(46B) and brake force equalizer (17).

### BACKGROUND OF THE INVENTION

In the past, conveyances such as wagons have been rigid boxes with rigid axles for attaching the wheels. Roadways having rough surfaces caused disturbing jolts to be transmitted to the cargo or passengers. Later improvements, as in buggies, added springs between the wagon box and the rigid axles, or between the passenger seat and the wagon box.

Modern vehicles, as in automobiles, have successfully approached this problem, but with increased complexity and expense. Many modern vehicles include an independent suspension for each wheel. These suspensions require many separate connected elements between the wheel and the box (chassis). Rigid axles have often been eliminated.

In modern automobiles, and other four-wheeled devices, each wheel may require two “A” frames, six pins and bushings, two ball joints, a coil spring and a mounted shock absorber. This requirement totals fifty-eight items for all four wheels, many of which require expensive tooling, and are costly to produce.

The many elements required for independent four-wheel suspension are, in prior art, made of high-strength and expensive materials. Facilities to produce such elements are often available only in advanced countries with high technology. FIG. 6, taken from Glenn's Automotive Repair Manual, 1966, shows a suspension for one wheel, with identification of the many parts. An illustration of front suspension components, FIG. 4, is taken from the repair manual for Chevrolet truck.

Simple wagons and carts, and also bicycles, are often used in remote villages in third-world countries.

The introduction of modern high-powered luxurious automobiles into such remote areas is not practical because of the:

(a). lack of modern smooth highways

(b). lack of convenient refueling and repair facilities.

(c). resultant large increase of polluting gases which can contribute to global warming.

(d). poverty of the land and people.

(e). scarcity of bridges and tunnels.

(f). lack of good harbors at ocean side.

### PRIOR ART

Examples from Prior Art show rigid connections between frame elements, thus creating joints with high stress concentrations, making the overall assembly inoperable under heavy use. Refer U.S. Pat. No. 3,794,352 Popp, U.S. Pat. No. 3,902,738 Gandrud.

Attempts in Prior Art to make improvements by adding to the weight and complexity of bicycles, reveal an unawareness that bicycles, by continuous successful design, are remarkably simple and light weight. Refer U.S. Pat. No. 750,480 McLarty, U.S. Pat. No. 4,227,589 Chika, U.S. Pat. No. 4,288,089 Thiessen, U.S. Pat. No. 4,290,620 Chika, U.S. Pat. No. 4,834,410 Parker, U.S. Pat. No. 6,068,278 Kock.

Attempts in Prior Art to add a power source fail to acknowledge the added weight and stress imposed on the rigid frames utilized. Refer U.S. Pat. No. 5,511,809 Sagi. Attempts in Prior Art to create a viable powered four-wheel device for human transport, based on bicycle technology have not resulted in tremendous sales. Refer U.S. Pat. No. 4,217,970 Chika.

Typical in Prior Art is the use of conventional sprocket-and-chain drives for each rear wheel, or a rotating drum (drive roller) engaging one or more of the tires. This Prior Art is expensive or dangerous. The rotating drum may deflect water, mud, or sand toward the operator, or, by friction, destroy the tire. Refer U.S. Pat. No. 4,217,970 Chika and U.S. Pat. No. 5,511,809 Sagi.

### Invention Disclosure

Inventor: Rudolph G. Larson

Address: P.O. Box 5654, Aurora, Ill. 60507, U.S.A.

Title of Invention: Resilient Supportive Structure

On or about Sep. 21, 1996, I felt a need for personal transportation apart from an automobile. My age would not permit a bicycle. I purchased two adult bicycles on Oct. 8, 1996 and disassembled unwanted parts. I then built a four-wheeled vehicle of a cheap and lightweight construction. On Jan. 9, 1997, I added new components which became the basis for my invention. Other necessary items were fabricated from available materials or purchased. I named the result a Resilient Supportive Structure as shown in the title of my patent application. It became apparent that my design was novel, and that it achieved an unobvious and unforeseen result. It provides means for each of the four wheels to move up or down while the vehicle is in motion, thus creating a smooth action over minor obstructions in a roadway surface.

I then created an engine mounting, a drive train, and steering and braking elements suitable to a powered vehicle, and seating for the operator. The vehicle was then field tested, on Oct. 4 & 5, 2000, on an asphalt pavement at speeds up to twenty miles per hour, and over varying terrain. Photographs were taken. Results of the field tests were good and acceptable. Actual copies of the photographs are shown in FIG. 34, SH 16 and FIG. 39, SH 17 of the drawings.

### OBJECTS AND ADVANTAGES

This RESILIENT SUPPORTIVE STRUCTURE will provide a result similar to that in recent modern vehicles, but at a greatly reduced cost, and lighter weight. Also, minimal tooling is required, so that existing factories may be used for mass production, even in poorer countries. Any four-wheeled device, from a child's toy to large farm machinery or military transport can be considered for application of this invention. The novel parts introduced are inexpensive to manufacture. In a vehicle for human transport, the addition of rotary power, fuel storage, or batteries is possible without over burdening other components. The supportive components are unique and are selected and constructed according to the intended use of the invention. The supportive components may vary greatly without avoiding the desired application of the invention to a large number of useful purposes. Much of prior art gives attention to devices made merely for pleasure. Present-day concerns call for an approach to needs for conserving energy, recycling, and a reduction of polluting gases. Application of the Resilient Supportive Structure to a vehicle for human transport encloses the operator within the rigid frames, with no body parts extending outward during normal operations. Refer FIGS. 18 and 20. The RESILIENT SUPPORTIVE STRUCTURE does not add to the weight and complexity of the portions incorporated from bicycles, and is novel and unique. The separate platform for the power source and drive wheel is superior, and not previously recognized. The location of the drive wheel assures that it functions cooperatively with the other wheels. Differential gearing is not required which is a great savings in manufacturing cost. Refer FIG. 3.

### SUMMARY

This invention, Resilient Supportive Structure, is a pre-selected set of unique supportive components, resiliently interfaced with elastic inserts. The resilient inserts are contained within and positioned around portions of the supportive components to form a totally integrated structure. Application of the invention to a significant embodiment is specified and claimed.

### INDEX TO ASSEMBLY DRAWINGS

Note: FIGS. 12, 17, and 30 are on the same

FIG. 1 Rigid Frame 1A, 1B

2 List

3 Showing 5, 12, 15, 16A, 16B and 30

4 Independent Suspension, Prior Art

5 Rigid Frame with forks

6 Independent Suspension, Prior Art

7 Cross Beams, 16A, 16B, 15, Frame 1A

8 Rigid Frame 5 with wheels 31A

9 Rigid Frame 9 with pads 19A, 19B

10 Showing 10A Beam 15, 10B Split Cincture

11 Cross Beams 16A, 16B, 15, Frame 1B

12 Driving wheel 45A, Axle 45B, Journal J

13 Ergonomic Study, Special for the Disabled

17 Equalizer with 42A, 42B, 43, 44A, 44B, and 47

18 Ergonomic Study, Standing

20 Ergonomic Study, Sitting

30 Showing 36, 37, 21, 26A, 27C

### DRAWING REFERENCE NUMERALS

1. Frame, Rigid (Tubing, Round 1A, Square 1B)

2. List

3. Assembly showing 5, 12, 15, 16A, 16B and 30

4. Independent suspension, Prior Art

5. Frame, Rigid, with forks: Swivel Fork 5A, Fixed Fork 5B

6. Independent suspension, Prior Art

7. Arrangement of cross beams; horizontal, vertical and transverse (round tubing).

8. Frame, Rigid, with wheels 31A and steering lever 46.

9. Frame, Rigid, with pads 19A and 19B for casters 40A and 40B.

10A. Figure showing assembly of beam 15 to rigid frames and to spacer 14, collar 23, pin 24, and nut 22.

10B. Figure showing assembly of beams 16A, 16B, to show split cinctures 41A, 41B, and split insert 26B.

11. Figure showing Resilient Supportive Structure using square tubing in rigid frames.

12. Figure showing driving wheel 45A, axle 45B, and pillow blocks J, assembled.

13. Figure showing proposed conveyance for the disabled.

14. Sleeve for transverse beam 15.

15. Beam, transverse, with shaft 21, nut 22, collar 23, pin 24, sleeve 14.

16A. Beam, horizontal.

16B. Beam, vertical

17. Equalizer, brake force.

17A. Figure showing orientation of equalizer assembly with swingletrees 44A and 44B and double swingletree 42A.

17B. Figure showing clamp 47 and cable 43 used in equalizer 17.

18. Ergonomic study. (standing)

19A. Pad for caster, swivel) 40A

19B. Pad for caster, fixed, 40B

20. Ergonomic study (sitting)

21. Shaft for beam 15

22. Nut NPT

23. Collar

24. Spring pin

25. Brace (gusset)

26A. Elastic insert, solid

26B. Elastic insert, split

27A. Cincture for horizontal beam 16A

27B. Cincture for vertical beam 16B

27C. Cincture for transverse beam 15 (in frame element 28C)

28A. Frame element, horizontal

28B. Frame element, vertical

28C. Frame element (for cincture 27C)

28D. Frame element, not oriented

29A. Axle

29B. Centerline, axle

30. Figure showing platform assembly with plate 36, subframe 37, cinctures 27C

31A. Wheel

31B. Centerline, wheel

32A. Nut

32B. Bolt

33. Washer

34. Photograph

35. Opening in plate 36 to accept wheel 45A

36. Plate

37. Subframe for assembly 30

38. Flange for cinctures 41A, 41B

39. Photograph

40A. Caster, swivel

40B. Caster, fixed

41A. Cincture, split, horizontal

41B. Cincture, split, vertical

42A. Swingletree, double

42B. Hole for cable 43

43. Cable, steel, brake

43A. Loop in cable 43

44A. Swingletree, left

44B. Swingletree, right

45A. Driving wheel

45B. Axle for wheel 45A

45C. Centerline of axle 45B

46A. Lever, steering, L.H.

46B. Lever, steering, R.H.

47. Clamp for cable 43

48CA. Holes in pad 19A for swivel caster 40A

48CB. Holes in pad 19B for fixed caster 40B

48EM. Holes for engine [E] or motor [M]

48GB. Holes for torque transmitting device [GB]

48J. Holes for pillow block [J]

49. Head shaft

### SPECIFICATION

1. This invention, a RESILIENT SUPPORTIVE STRUCTURE, is, in part:

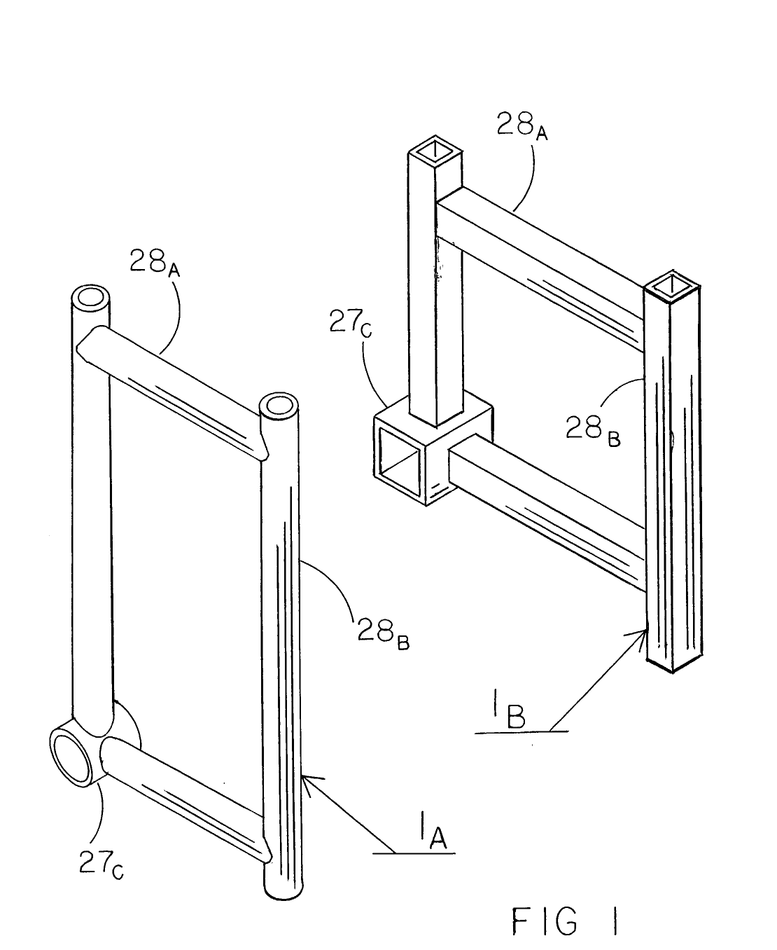

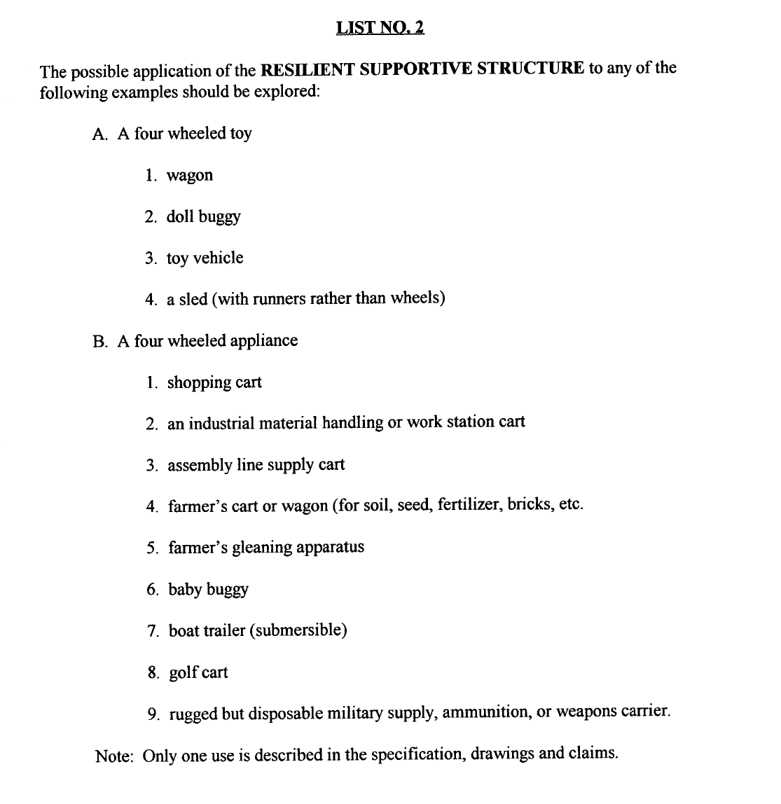

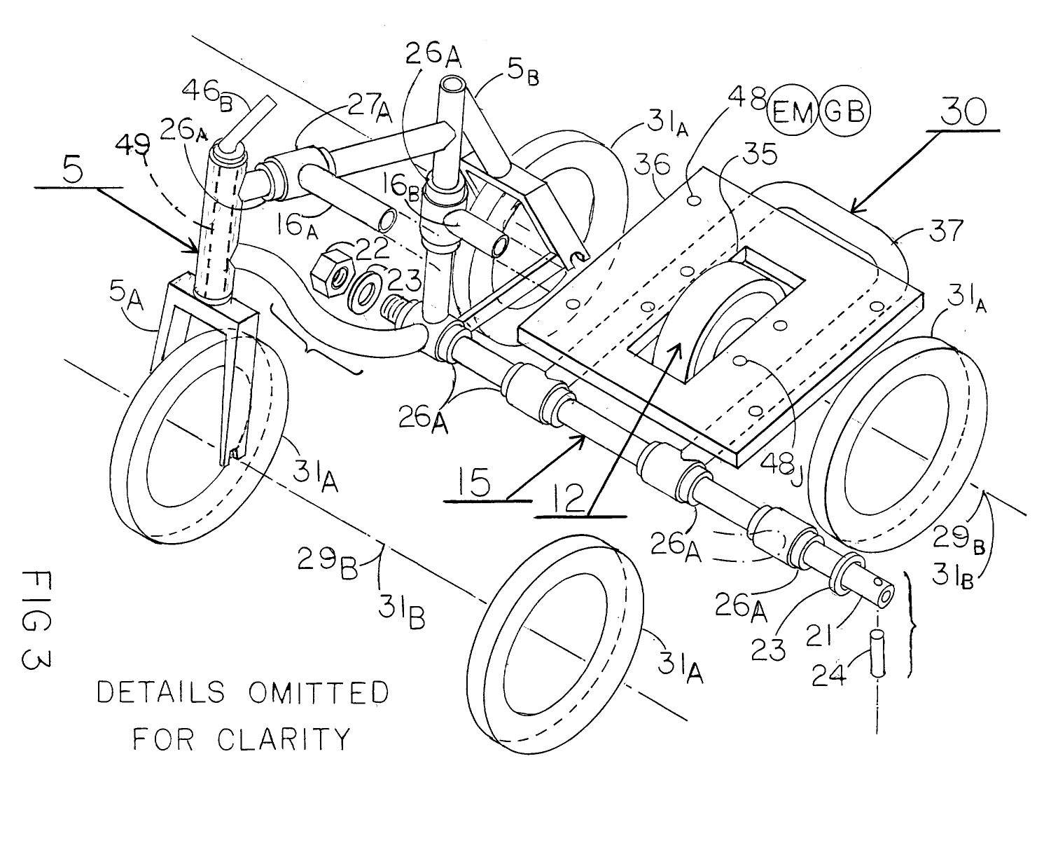

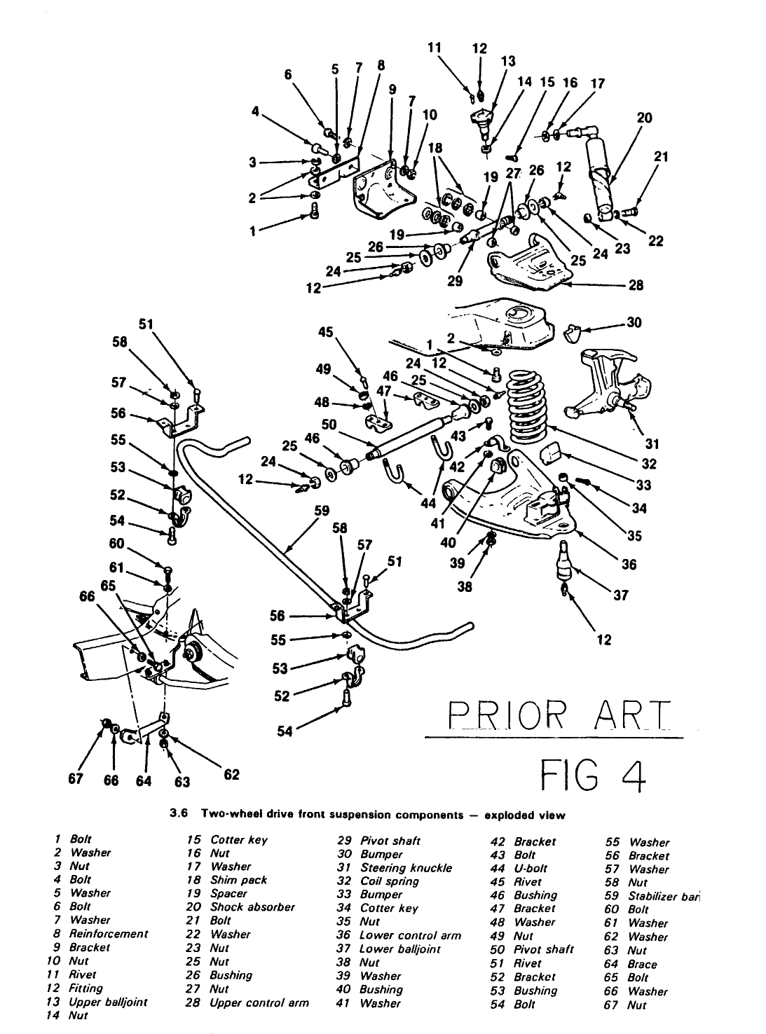

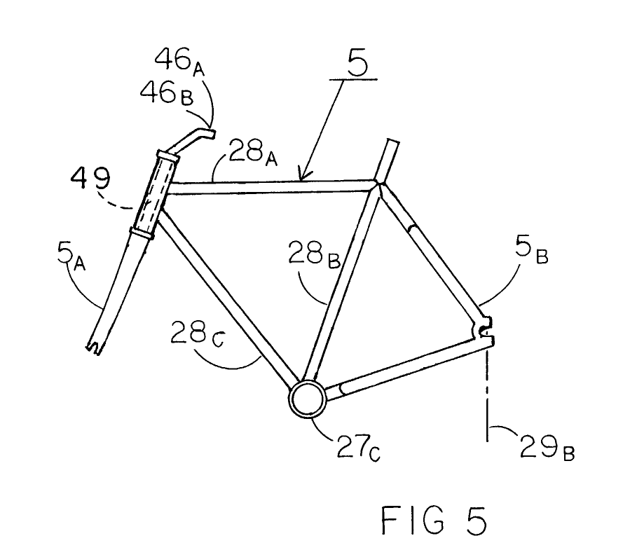

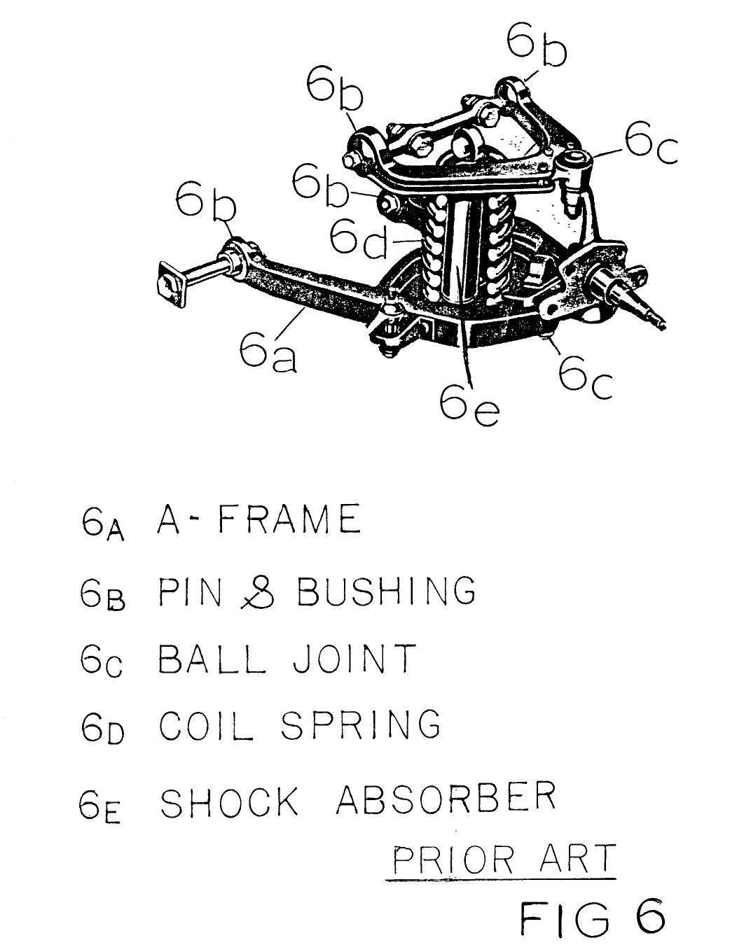

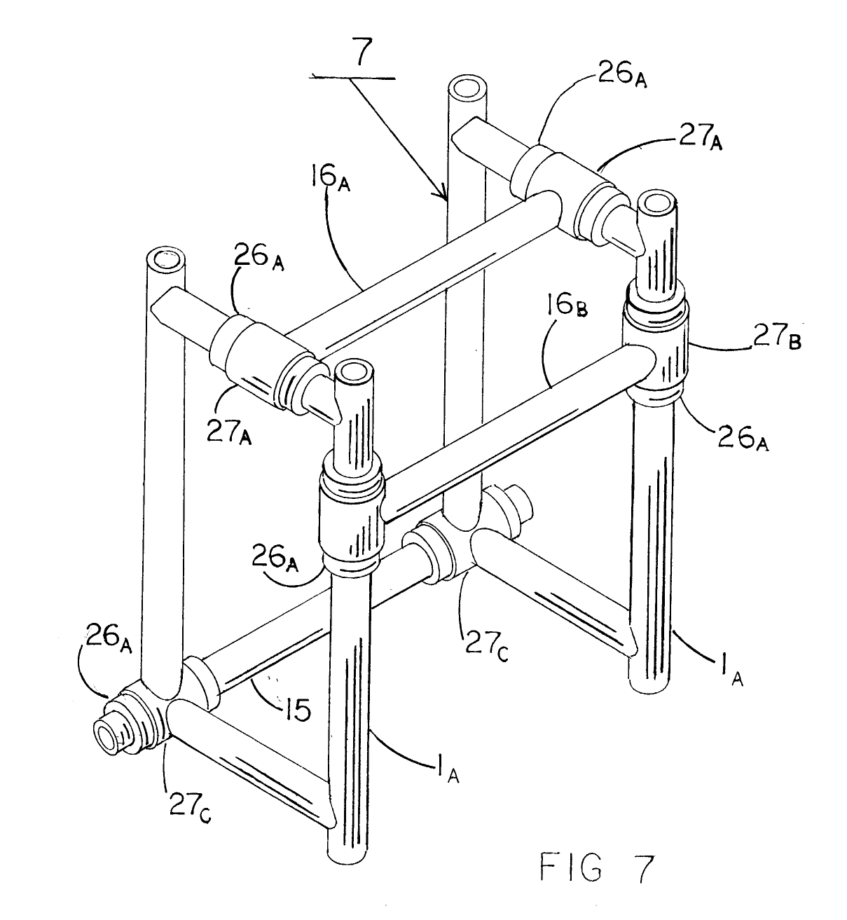

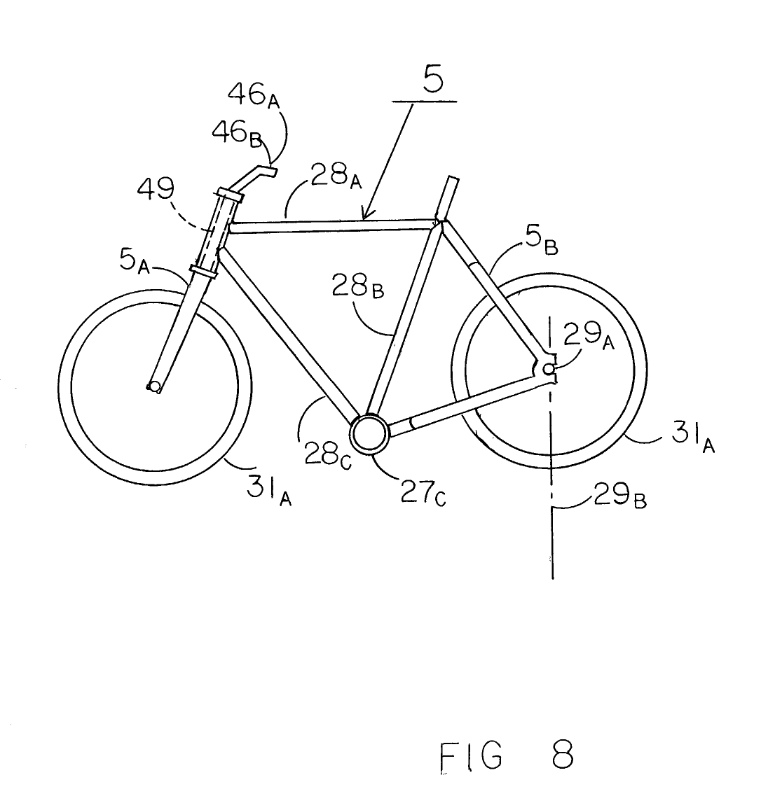

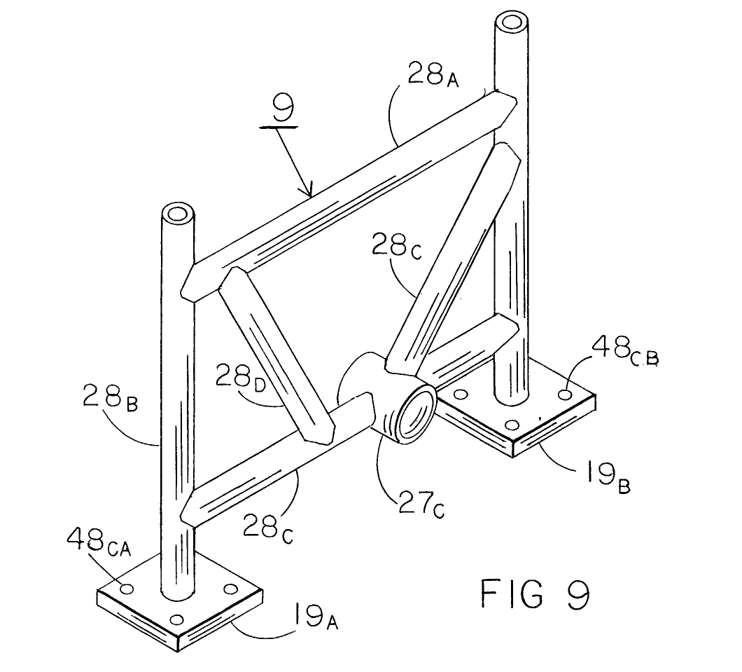

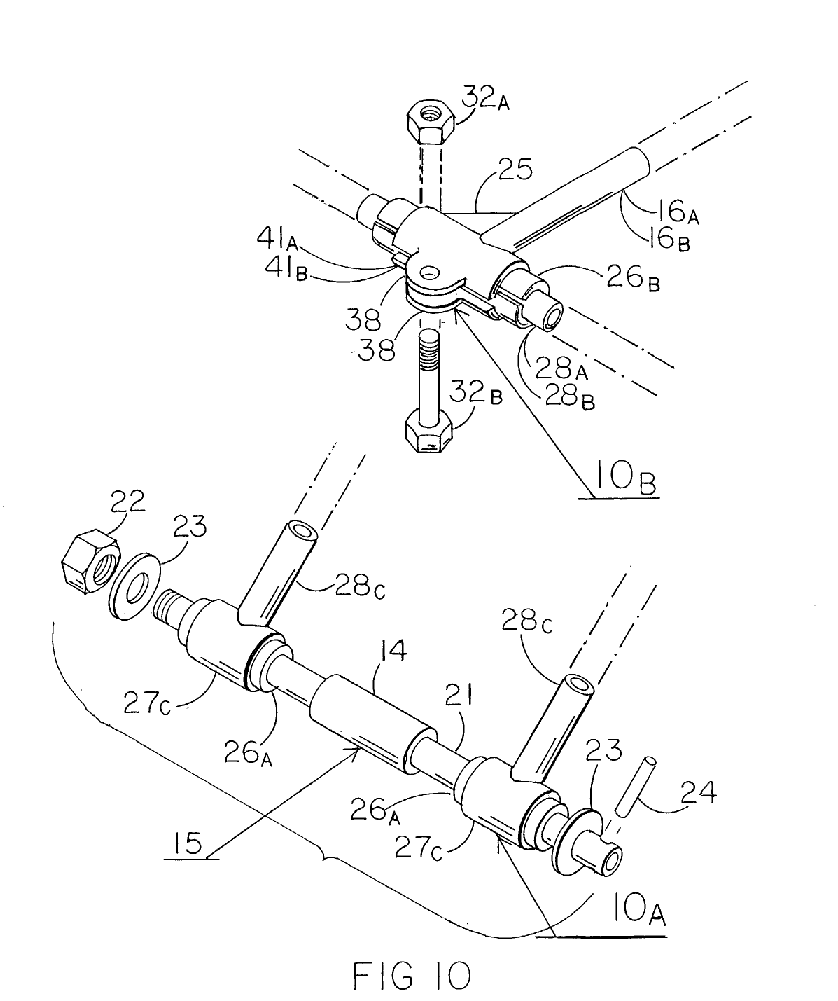

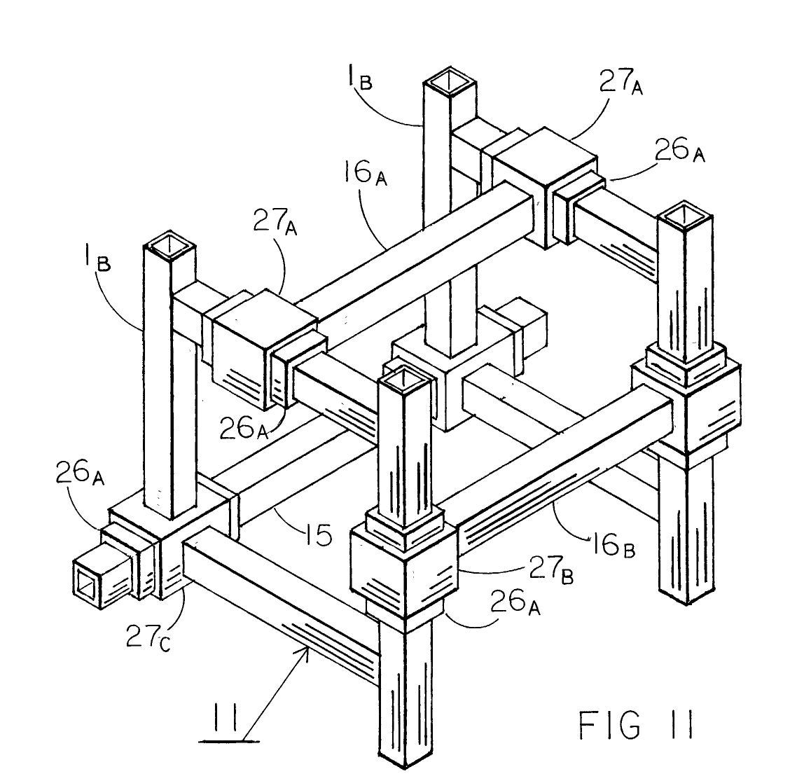

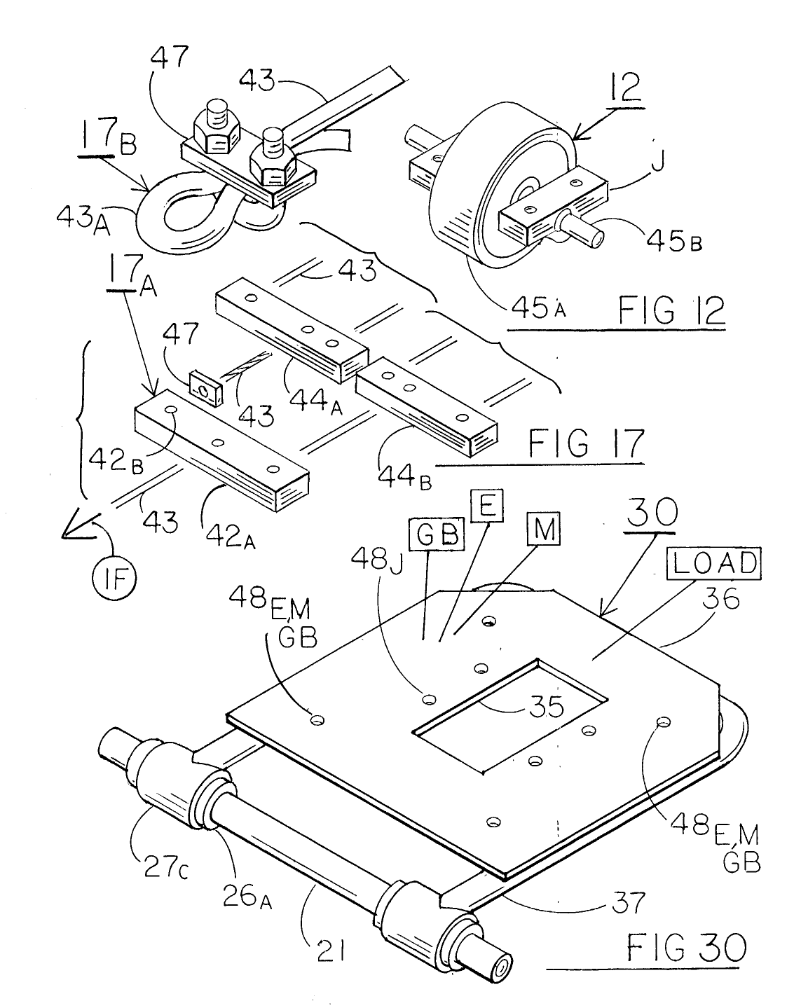

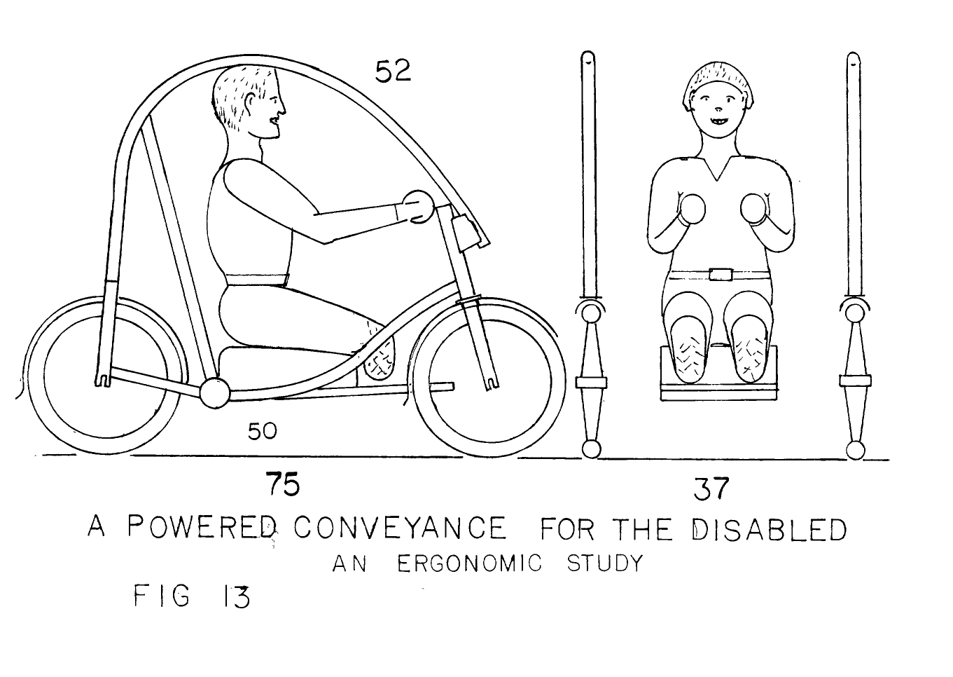

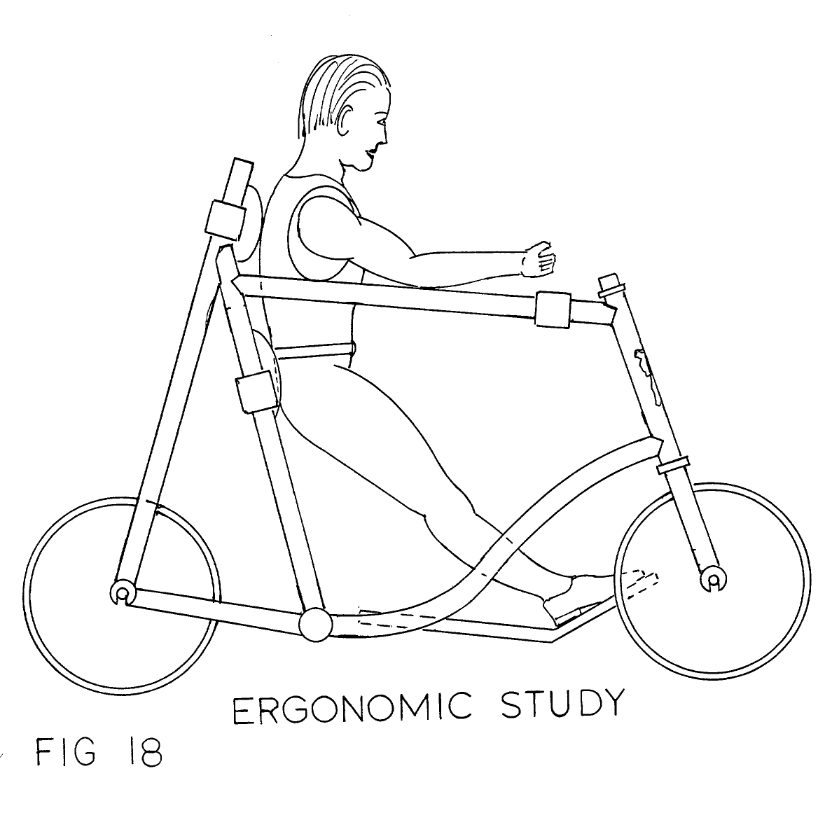

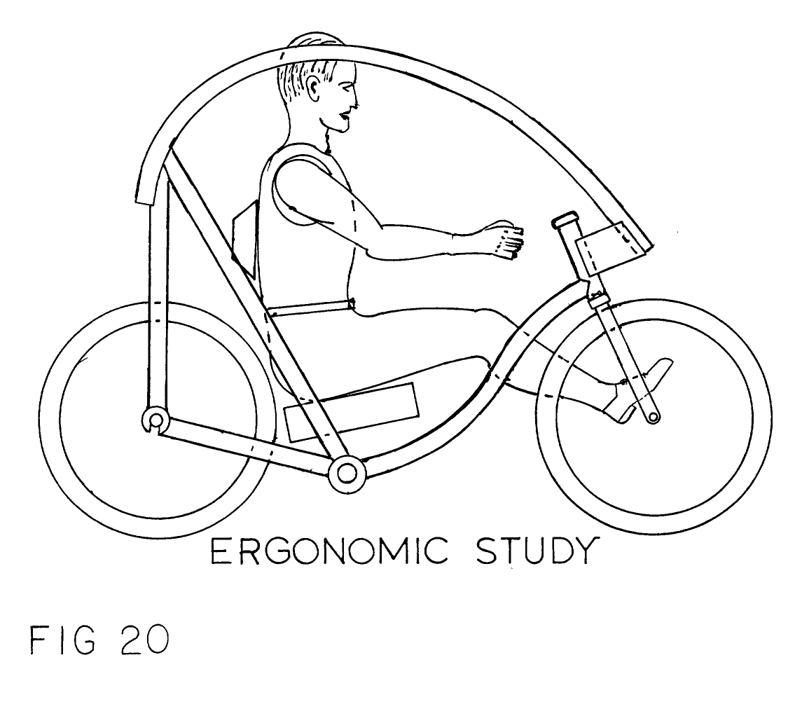

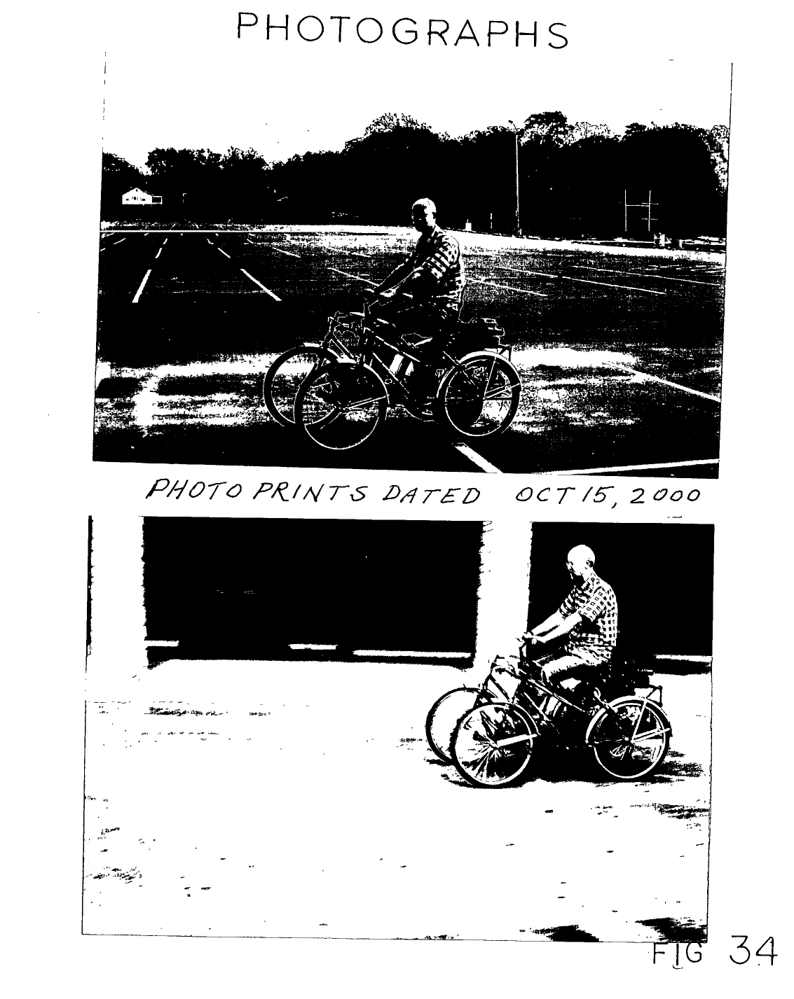

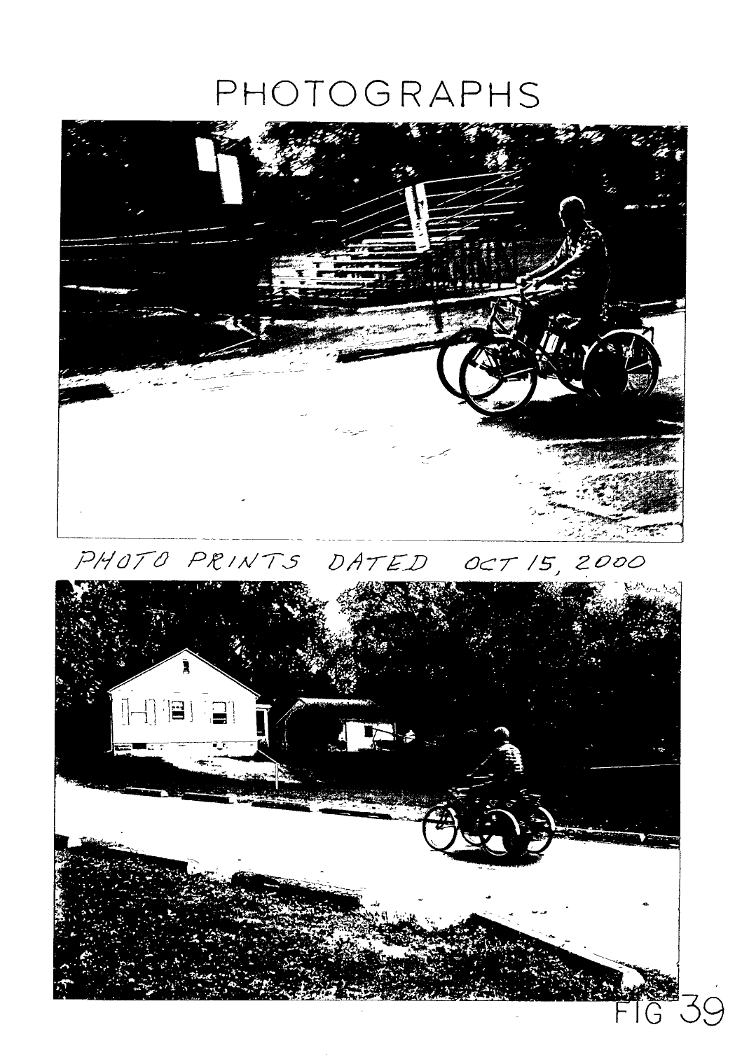

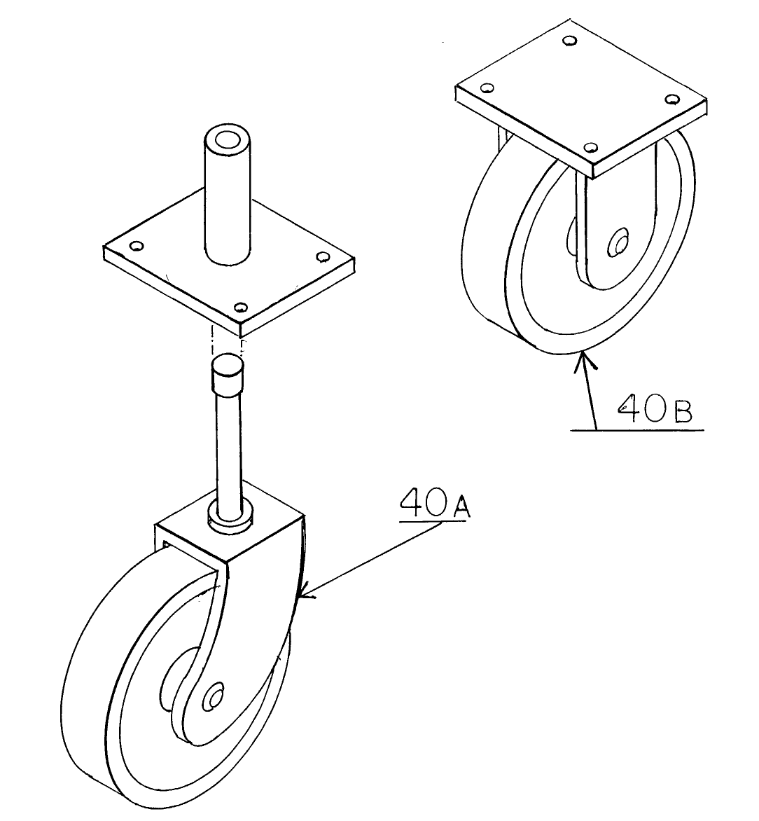

a. a plurality of rigid frames, pre-selected. Ref FIGS. 1, 5, 8, 9. Also see list 2.

b. a plurality of horizontal connecting cross beams 16A, each beam incorporating two horizontal cinctures 27A.

c. a plurality of vertical connecting cross beams 16B, each beam incorporating two vertical cinctures 27B.

d. a plurality of intervening elastic inserts 26A. Each cincture 27A, 27B encloses an insert 26A.

Each insert 26A surrounds a specific one of the elements 28A, 28B in the pre-selected rigid Frames 1, 5, 8, or 9. Each insert has a bore (internal dimension) 26D.

e. a third type of beam extending laterally (transversely) between the rigid frames 1, 5, 8, or 9. This transverse beam, 15, is based on shaft 21. Shaft 21 is inserted co-axially within two of the Elastic inserts 26A. The inserts 26A are placed within two cinctures 27C. These cinctures 27C are incorporated in (welded to) elements 28C of the rigid frames 1, 5, 8, or 9. See FIGS. 10A, 7, and 11. Also, in final assembly, transverse beam 15 includes a plurality of collars 23, spacers 14, a nut 22, and pin 24, as shown in FIG. 10B.

2. Also, in part, this invention, a RESILIENT SUPPORTIVE STRUCTURE, is a specific arrangement of cross beams 15, 16A, and 16B in relation to the rigid frames 1, 5, 8, or 9. The specific arrangement establishes that:

a. the cinctures 27A, on beam 16A, interact in a horizontal relationship to horizontal members 28A of pre-selected rigid frames 1, 5, 8, or 9.

b. the cinctures 27B on beam 16B interact in a vertical relationship to vertical members 28B of rigid frames 1, 5, 8, or 9.

c. the cinctures 27C interact with beam 15 in a transverse relationship. Refer FIGS. 3, 7, 10, and 11.

3. For ease of assembly, the following substitutions are used:

a. split insert 26B for insert 26A.

b. split cinctures 41A and 41B for cinctures 27A and 27B. Split cinctures 41A and 41B require nut 32A and bolt 32B, as shown in FIG 10B.

4. The assembly of three beams 15, 16A and 16B with cinctures 27A, 27B, 27C, and elastic inserts 26A, 26B, effectively connects two of the rigid frames 1, 5, 8, or 9 firmly but resiliently together. This resultant assembly maintains a fixed relationship between two of the frames 1, 5, 8, or 9, but allows minor relative motions between two of the frames 1, 5, 8 or 9.

5. The minor relative motions of frame 1, 5, 8, or 9 serve the purpose of allowing wheels 31A or casters 40A, 40B, to move up and down. The up and down motions permits wheels 31A or casters 40A, 40B to roll smoothly over obstructions in a roadway surface. This invention, a RESILIENT SUPPORTIVE STRUCTURE, thus contributes to the comfort of occupants, and also assures the stability and integrity of merchandise carried within the structure.

6. In an overall configuration, each elastic insert 26A, 26B, and its juxtaposed parts, must be located as far apart from the other elastic inserts 26A, 26B and their juxtaposed parts, as practical design will permit, so as to increase the leverage of each beam 15, 16A, 16B, to the other beams 15, 16A, and 16B. This increased leverage enhances the overall stability of the entire structure.

### Selected Embodiment

7. The figures and paragraphs which follow refer to an embodiment of the RESILIENT SUPPORTIVE STRUCTURE for a specific use.

8. With details omitted for clarity, FIG. 3 shows the assembly of platform 30, driving wheel assembly 12, transverse beam 15, two rigid frames 5, and cross beams 16A and 16B. FIG. 3 represents the application of the RESILIENT SUPPORTIVE STRUCTURE to a powered vehicle for human transport. Details for steering, braking and seating are conventional and are not shown.

9. In a vehicle for human transport, the added rotary power can be in the form of a battery-and-electric motor [M], or an internal combustion engine [E]. The devices [M] and [E] are conventional, and are available, or under development, at commercial sources.

10. Plate 36 and subframe 37, parts of platform assembly 30, are shown in FIG. 30. Plate 36 contains mounting holes 48EM, and 48GB to accommodate either an engine [E] or electric motor [M] and/or a rotary-motion transmitting device [GB]. Plate 36 also contains mounting holes 48J to accommodate pillow blocks [J]. The items [E], [M], [GB], and [J], are conventional purchased and are not shown.

11. The methods of application of items [E], [M], [GB], and [J], are well-known to those skilled in the mechanical arts, and also to those correctly making use of manufacturers' guidelines.

12. This invention, a RESILIENT SUPPORTIVE STRUCTURE, by the use of six elastic inserts 26A, 26B, creates a comfortable ride for the operator. Any vibrations from the power sources [EM], are constrained by the elastic inserts 26A, 26B at separate consecutive positions before reaching the seat (not shown) of the operator. Each pair of inserts 26A, 26B is oriented differently as horizontal, vertical, and transverse. This feature is very cost effective because it is accomplished by using the same inserts 26A, 26B which provided independent suspension for wheels 31A or casters 40A, 40B. Refer FIGS. 3, 7, and 11, and inserts 26A, 26B.

### Remarks, General

13. Effective function is achieved, even though, in a given structure, each elastic insert 26A, 26B, and its juxtaposed parts, is not of the same size as other inserts 26A, 26B and their juxtaposed parts.

14. Optionally, the elastic inserts 26A, 26B may have a square, oval, or any regular or irregular polygonal bore 26D. The bore 26D must be equal in its inside dimension to the outer dimension of elements 28A, 28B in rigid frames 1, 5, 8, or 9.

15. Optionally, the elastic inserts 26A, 26B, may have a square, oval, or any regular or irregular polygonal outer dimension. The outer dimension must be equal to the inside dimension of cinctures 27A, 27B, 27C.

16. Referring to paragraphs 14 and 15 above, an optional working combination, essential to the support and resilience of the entire structure or vehicle, is accomplished. This is done in a similar manner as was used for round tubing.

### Other Features

17. The orientation of elements to create a brake-force-transmitting device 17 is shown in FIG. 17A. An initiating force [IF], controlled by the operator, and delivered via cable 43 to the central typical hole 42B in swingletree 42A, is further delivered to the central holes 42B in swingletrees 44A and 44B. The cable 43 and clamp 47 are conventional items and are not completely shown.

18. Also shown in FIG. 17A, are four (typical) outer holes 42B in swingletrees 44A and 44B. Each brake cable 43 emanating from an outer hole 42B is further extended to reach as far as each wheel 31A (not shown).

19. Details of how a loop is created in cable 43 are shown in FIG. 17B. In each instance, a loop 43A, so fashioned, is passed through one of the nine typical holes 42B in swingletrees 42A, 44A, and 44B, and then clamped, using clamp 47.

20. Other cable clamping devices, common and conventional in the mechanical arts, can serve in place of clamp 47.

### Other Uses

21. Because of the many potential applications of the RESILIENT SUPPORTIVE STRUCTURE, there is no preferred embodiment presented. The simplest configurations, upon which other devices may be based, are shown in FIGS. 7 and 11.

22. Ergonomic studies, FIGS. 13, 18, and 20, show proposed uses of the RESILIENT SUPPORTIVE STRUCTURE to special applications, as an operator in a standing posture, FIG. 18, or a sitting posture, FIG. 20, or for the handicapped, FIG. 13.

23. Refer to List No. 2 which offers many suggestions for possible application of RESILIENT SUPPORTIVE STRUCTURE. For a light weight personal vehicle, the facilities for bicycle manufacture are available at American and foreign sources.

### Drawing Figures

In the drawings, closely related parts and figures have the same number but different suffixes. I do not desire to be limited to the exact details of construction shown and described, for obvious modifications will occur to a person skilled in the art.

The scope of this invention should be determined by the appended claims and their legal equivalents rather than by the examples shown.

Preamble: In a mobile appliance with wheels, an economical means to provide independent suspension for each wheel, and equal braking for each wheel, and a mounting: (a) for a rotary power source, or (b) for a load.

I claim:

1. a multi-faceted, limitedly-flexible framework, entitled RESILIENT SUPPORTIVE STRUCTURE, comprising:
a. a plurality of rigid frames, said frames made from strong, substantially rigid, round, or oval or polygonal tubular elements, said elements securely attached to each other.
b. a plurality of cross beams, said beams made from strong, substantially rigid, round, oval, or polygonal tubing, to provide a required spacing between said frames.
c. a plurality of cinctures, said cinctures made from strong, substantially rigid, round, oval, or polygonal tubing, and securely attached to:
(1). each end of said cross beams.
(2). two or more of the said elements in said frames.
d. a plurality of cinctures, each said cincture to provide an enclosure for said inserts.
e. a plurality of intervening elastic inserts, said inserts made from tough, resilient material, to provide controlled relative motion of said frames.
f. a plurality of elastic inserts, each said insert made of a pre-selected durometer hardness.
g. a plurality of elastic inserts, each said insert surrounding one of said cross beams.
h. a plurality of elastic inserts, each said insert surrounding one of said elements in said frames.
i. an orientation of at least three of said cross beams, including said cinctures and said inserts, as horizontal, vertical or transverse, to provide resiliency and stability to said framework.

2. the framework of claim 1, further including first means, as a plurality of mounting devices, as pads, for casters, to provide mobility.

3. the framework of claim 1, further including second means, as a plurality of mounting devices, as forks, for axles and wheels, to provide mobility.

4. the framework of claim 1, further including third means, as a plurality of levers and head-shafts, supported by bearings, to orient a pair of said wheels about a substantially vertical axis, to provide steering.

5. the framework of claim 1, further including fourth means, as a platform assembly, comprising a plate and subframe, incorporating said cinctures enclosing said elastic inserts enclosing one said cross beam, for mounting a rotary power device, with journals, axle and drive wheel, to impart motion to the entire structure, or to provide a surface to carry loads.

6. the framework of claim 1, further including fifth means, as a chain of three swingletrees connected in a series/parallel arrangement; with a plurality of cables and clamps, to enable a braking force to be transmitted to a plurality of said wheels in substantially equal portions at the same time.

7. the framework of claim 1, claim 3, and claim 5, further including sixth means, to dispose said journals of claim 5 in a substantially vertical common plane, as contains two said axles of claim 3, to maintain true rolling of said wheels of claim 3.
